(19) United States
(12) Patent Application Publication
(10) Pub. No.: US 2026/0097645 A1
(43) Pub. Date: Apr. 9, 2026

(54) Fixation Device of Hydrogen Storage Module for Vehicle

(71) Applicants: Hyundai Motor Company, Seoul (KR); Kia Corporation, Seoul (KR)

(72) Inventor: Sung Won Park, Hwaseong-si (KR)

(21) Appl. No.: 19/226,679

(22) Filed: Jun. 3, 2025

(30) Foreign Application Priority Data
Oct. 8, 2024 (KR) 10-2024-0137129

(51) Int. Cl. B60K 15/067; B60K 15/03; F17C 13/08

(52) U.S. Cl. CPC B60K 15/067; F17C 13/084; B60K 2015/03315; B60K 2015/0675; F17C 2205/0103; F17C 2221/012; F17C 2270/0168

(57) ABSTRACT

The present disclosure relates to a mount for a hydrogen storage tank of a vehicle. The mount may include an insulator configured to insulate vibration of the hydrogen storage tank; and a plurality of stoppers. The plurality of stoppers may include a first stopper and a second stopper. The first stopper may include a first attachment surface supporting an upper surface of the insulator. The second stopper may include a second attachment surface supporting a lower surface of the insulator.

### CROSS-REFERENCE TO RELATED APPLICATION

This application claims priority to Korean Patent Application No. 10-2024-0137129, filed in the Korean Intellectual Property Office on Oct. 8, 2024, the entire contents of which are incorporated herein by reference.

### TECHNICAL FIELD

The present disclosure relates to a hydrogen storage device for a vehicle, and more particularly, to a mount for the hydrogen storage device.

### BACKGROUND

Eco-friendly vehicles, such as hybrid vehicles, electric vehicles, and hydrogen-powered vehicles, may be equipped with high-voltage batteries that provide electric power to a driving motor.

In particular, the hydrogen-powered vehicles may be equipped with a fuel battery system that is configured to charge a high-voltage battery with electric power.

To drive their motors, the hydrogen-powered vehicles may generate their own electricity through a chemical reaction between hydrogen and oxygen. The hydrogen-powered vehicles may include a hydrogen tank that stores hydrogen gas, an air compressor that supplies air, and a fuel cell stack that generates electric energy through an electrochemical reaction between the hydrogen gas and the air.

The hydrogen tank mounted on the hydrogen-powered vehicle may store high-pressure hydrogen gas. The hydrogen gas may be, for example, discharged to a high-pressure fuel line according to an operation of a solenoid valve mounted at an inlet of the hydrogen tank, decompressed by the regulator, and supplied to the fuel cell stack.

For efficient supply of hydrogen to the fuel cell stack, a plurality of hydrogen tanks may be mounted on the hydrogen-powered vehicle.

The hydrogen tank may include hydrogen storage coupled with a frame structure that is fixed to the hydrogen-powered vehicle.

### SUMMARY

The present disclosure has been made to solve the above-mentioned problems occurring in at least some implementations while advantages achieved by those implementations are maintained intact.

An aspect of the present disclosure provides a fixation device of a hydrogen storage module for a vehicle, by which insulation of vibration of a road, which is transmitted to the hydrogen storage module, and forward/rearward direction (e.g., longitudinal direction) or leftward/rightward direction (e.g., lateral direction) characteristics as well as upward/downward characteristics of the hydrogen storage module may be selectively controlled as well.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a mount for a hydrogen storage tank of a vehicle may include: an insulator configured to insulate vibration of the hydrogen storage tank; and a plurality of stoppers. The plurality of stoppers may include a first stopper and a second stopper. The first stopper may include a first attachment surface supporting an upper surface of the insulator. The second stopper may include a second attachment surface supporting a lower surface of the insulator.

The mount may further include: a washer provided at an upper portion of the first stopper and configured to adjust, by a thickness of the washer, a vertical position of the insulator.

The insulator may include: two rubber dampers, of different degrees of hardness, being coupled to each other.

The two rubber dampers may include: a first rubber damper; and a second rubber damper having a lower degree of hardness than the first rubber damper. The second rubber damper may be coupled to an upper side of the first rubber damper.

The first rubber damper may include: a disk body having a first diameter; and a support disk formed on the disk body. The disk body and the support disk may be concentric. The support disk may have a second diameter that is less than the first diameter. The first rubber damper may further include an insertion disk formed on the support disk. The support disk and the insertion disk may be concentric. The insertion disk may have a third diameter that is less the second diameter.

The second rubber damper may include: a torus body with a through-hole, into which the insertion disk of the first rubber damper is inserted and affixed.

Each of the plurality of stoppers may further include a vertical circular wall extending vertically along a circumference of at least one of the first attachment surface or the second attachment surface.

Each of the plurality of stoppers may be configured to adjust, by a length of the vertical circular wall, a vertical position of the insulator.

Each of the plurality of stoppers may include a plurality of extension grooves integrally extending outward from the vertical circular wall.

The plurality of extension grooves may include a pair of extension grooves that are disposed on opposite sides of the vertical circular wall.

The insulator may be disposed between the first stopper and the second stopper such that a first circular wall of the first stopper and a second circular wall of the second stopper are in contact with the insulator. A first through-hole may be formed on the insulator. The insulator may be inserted through a second through-hole that is formed on a first bracket. The first bracket may be affixed to the hydrogen storage tank.

The mount may further include a bolt penetrating through: a through-hole formed on a second bracket, a through-hole formed on a first disk of the first stopper, the first through-hole, the second through-hole, a through-hole formed on a second disk of the second stopper, a washer disposed on the second stopper, and a nut disposed on the washer. The second bracket may be affixed to a body frame of the vehicle.

According to one or more example embodiments of the present disclosure, a mount for a hydrogen storage tank of a vehicle may include a first stopper including a first disk and a first circular wall vertically extending from a first circumferential edge of the first disk. A first through-hole may be formed on the first disk. The first through-hole may be concentric to the first disk. The mount may further include a second stopper including a second disk and a second circular wall vertically extending from a second circumferential edge of the second disk. A second through-hole may be formed on the second disk. The second through-hole may be concentric to the second disk. The mount may further include an insulator disposed between the first stopper and the second stopper such that the first circular wall and the second circular wall are in contact with the insulator. A third through-hole may be formed on the insulator. The insulator may be inserted through a fourth through-hole that is formed on a first bracket. The first bracket may be affixed to the hydrogen storage tank. The mount may further include a bolt penetrating through: a fifth through-hole formed on a second bracket, the first through-hole, the third through-hole, the fourth through-hole, the second through-hole, a washer disposed on the second stopper, and a nut disposed on the washer. The second bracket may be affixed to a body frame of the vehicle.

The insulator may include two rubber dampers, of different degrees of hardness, being coupled to each other.

One of the two rubber dampers may include: a disk body having a first diameter; a support disk formed on the disk body. The disk body and the support disk may be concentric. The support disk may have a second diameter that is less than the first diameter. The rubber damper may further include an insertion disk formed on the support disk. The support disk and the insertion disk may be concentric. The insertion disk may have a third diameter that is less the second diameter.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating a mount for a hydrogen storage tank of a vehicle;

FIG. 2 is an exploded perspective view illustrating a mount for a hydrogen storage tank of a vehicle;

FIG. 3 is a partially cutaway perspective view of a mount for a vehicle hydrogen storage tank fixed (e.g., affixed) to the upper and lower brackets;

FIG. 4 is a perspective view illustrating stoppers of a mount for a hydrogen storage tank of a vehicle;

FIG. 5 is a view illustrating an arrangement state of an extension groove part of a stopper for adjusting forward/rearward direction (e.g., longitudinal direction) characteristics of an insulator;

FIG. 6 is a view illustrating an arrangement state of an extension groove of a stopper for adjusting leftward/rightward direction (e.g., lateral direction) characteristics of an insulator;

FIG. 7 is a view illustrating an arrangement state of an extension groove of a stopper for adjusting forward/rearward (e.g., longitudinal) and leftward/rightward (e.g., lateral) direction characteristics of an insulator; and

FIG. 8 is a graph depicting an adjustment range between hardness characteristic curves of an insulator according to adjustment of a height of a stopper according to the present disclosure.

### DETAILED DESCRIPTION

Hereinafter, one or more example embodiments of the present disclosure will be described in detail with reference to the accompanying drawings. In adding reference numerals to the components of the drawings, it should be noted that the same components have the same numerals as possible even when they are illustrated on different drawings. In describing the example embodiments of the present disclosure, detailed descriptions associated with well-known functions or configurations will be omitted if they may make subject matters of the present disclosure unnecessarily obscure.

Furthermore, in describing components of the example embodiments of the present disclosure, the terms first, second, A, B, (a), (b), and the like may be used herein. These terms are only used to distinguish one component from another component, but do not limit the corresponding components irrespective of the nature, order, or priority of the corresponding components. When it is described that a certain component is “connected to”, “coupled to” or “electrically connected to” a second component, it should be understood that the component may be directly connected or electrically connected to the second component, but a third component may be “connected”, “coupled” or “electrically connected” between the components.

At least in some implementations of the hydrogen storage of a hydrogen-powered vehicle, a structural hardness (e.g., integrity) of the frame structure that supports the hydrogen tank may not be sufficient, and the movement of the hydrogen storage module in the forward/rearward direction (e.g., longitudinal direction) or the leftward/rightward direction (e.g., lateral direction) may increase. Thus, any physical impact on the hydrogen storage module may directly be transmitted to the vehicle during a turn or an abrupt stop of the vehicle. Such an unstable behavior may lead to decreased durability of the frame structure due to the continuous impact and vibration of the hydrogen storage module.

Hereinafter, a mount for a hydrogen storage tank of a vehicle according to one or more example embodiments of the present disclosure will be described in detail with reference to the accompanying drawings.

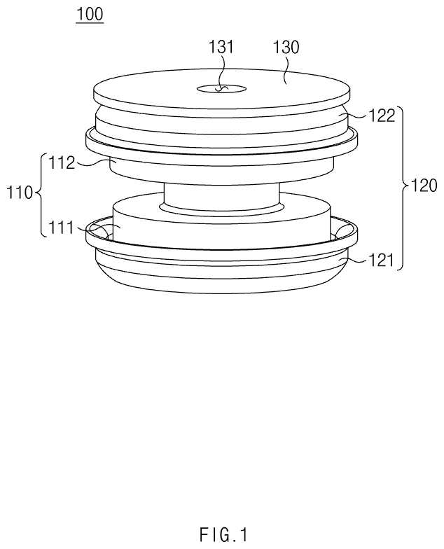

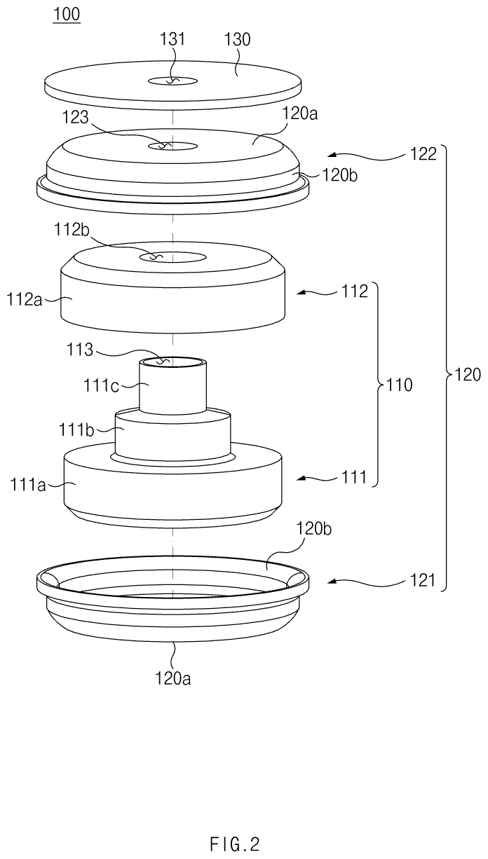

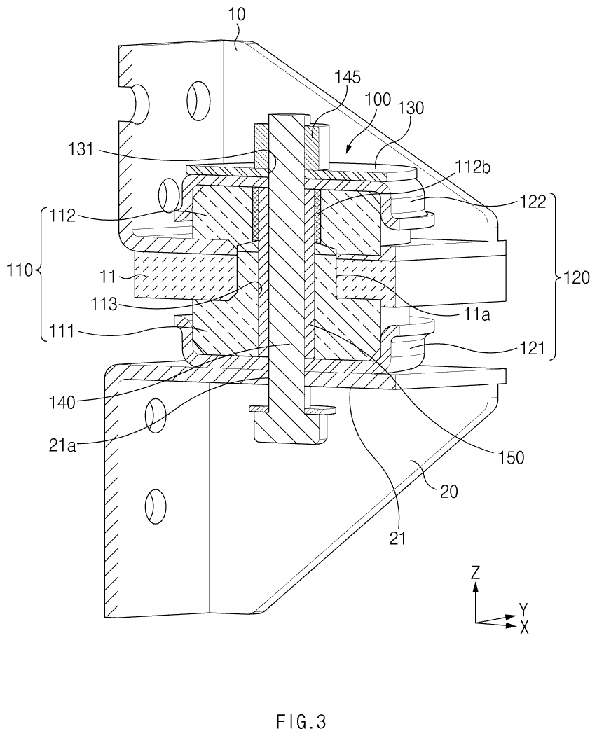

FIG. 1 is a perspective view illustrating a mount for a hydrogen storage tank of a vehicle. FIG. 2 is an exploded perspective view illustrating a mount for a hydrogen storage tank of a vehicle. FIG. 3 is a partially cutaway perspective view of a mount for a vehicle hydrogen storage tank fixed (e.g., affixed) to the upper and lower brackets.

Referring to the accompanying drawings, the mount (also referred to as a fixation device) of the hydrogen storage tank (also referred to as the hydrogen storage module) of a vehicle according to the present disclosure may include a damping device 100 that may control upward/downward direction (e.g., vertical direction) characteristics, forward/rearward direction (e.g., longitudinal direction), or leftward direction characteristics while being fixed (e.g., affixed) between a frame structure (not illustrated) for fixing (e.g., affixing) a hydrogen tank (not illustrated) to a hydrogen-powered vehicle (a truck or a bus) and a vehicle body frame (not illustrated) to secure vibration insulation.

Throughout the present disclosure, a combination of a hydrogen tank and a frame structure that supports the hydrogen tank may be referred to as a hydrogen storage module, a hydrogen storage assembly, or just simply referred to as a hydrogen tank.

The damping device 100 may be fixed (e.g., affixed) between the hydrogen storage module (e.g., hydrogen storage tank) and the vehicle body frame via an upper bracket (also referred to as a first bracket) 10 and a lower bracket (also referred to as a second bracket) 20. As an example, the upper bracket 10 may be fixed (e.g., affixed) to the frame structure of the hydrogen storage module (e.g., hydrogen storage tank), and the lower bracket 20 may be fixed (e.g., affixed) to the vehicle body frame.

As illustrated in FIGS. 1 and 2, the damping device 100 according to the present disclosure may include an insulator (also referred to as an insulator layer) 110 and stoppers 120.

In the insulator 110, rubber dampers for connection to the hydrogen storage module (e.g., hydrogen storage tank) and the vehicle body, respectively, may be located on upper and lower sides. In the insulator 110, the first and second rubber dampers (also referred to as bushes or bushings) 111 and 112 having different degrees of hardness may be coupled to each other as one damper.

Here, the second rubber damper 112 may have a soft hardness that is lower than that of the first rubber damper 111. Furthermore, the first rubber damper 111 may have a hardness that is relatively higher than that of the second rubber damper 112.

The first rubber damper 111 may include a first body part (also referred to as a first body, a first disk, a first disk body, a body disk) 111a having a disk shape. The first rubber damper 111 may include a support part (also referred to as a support, a support disk, or a second disk) 111b that supports the second rubber damper 112 on the first body part 111a.

The support part 111b is formed in a disk shape that is formed at an upper portion of the first body part 111a while sharing a center of (e.g., concentric with) the first body part 111a, and a diameter of which is smaller than that of the first body part 111a.

The first rubber damper 111 may include an insertion part 111c that is inserted into a through-hole 112b of the second rubber damper 112 on the support part 111b.

The insertion part (also referred to as an insert, a third disk, an insertion disk, or an insert disk) 111c is formed in a disk shape that is formed at an upper portion of the support part 111b while sharing a center of the support part 111b, and a diameter of which is smaller than that of the support part 111b.

The second rubber damper 112 may include a second body part 112a having a disk shape. The second body part 112a may be a torus (e.g., a toric body). The through-hole 112b, into which the insertion part 111c of the first rubber damper 111 is inserted to be fixed (e.g., affixed), may be formed at a central portion of the second body part 112a. When the insertion part 111c is inserted into the through-hole 112b, the insertion part 111c may be inserted through an interference-fitting manner, in which the insertion part 111c is not easily separated from the through-hole 112b, to be fixed (e.g., affixed).

The insulator 110 may be limited to a configuration, in which the first rubber damper 111 and the second rubber damper 112 are separated from each other, but the present disclosure is not limited thereto, and they may be integrally coupled to each other. However, two rubber dampers having different degrees of hardness may be integrally coupled to the insulator 110.

Furthermore, a shaft hole 113, in which a shaft pipe 150 is installed, may be formed at a central portion of the first rubber damper 111. The shaft pipe 150 may have a thread formed on an inner peripheral surface thereof so that a fastener (also referred to as a fastening member) 140, such as a bolt, is fastened thereto, and an outer peripheral surface thereof may be a path, in which the first rubber damper 111 coupled with the second rubber damper 112 may absorb vibration.

The insulator 110 including the first rubber damper 111 and the second rubber damper 112 may be compressed, prolonged, and twisted to adjust rubber characteristics for respective directions, such as an upward/downward direction (e.g., vertical direction), a forward/rearward direction (e.g., longitudinal direction), or a leftward/rightward direction (e.g., lateral direction). In particular, because the second rubber damper 112 is formed of a rubber damper having a lower hardness than that of the first rubber damper 111, an upward/downward (e.g., vertical) behavior of the second rubber damper 112 may be implemented with low rubber characteristics. Accordingly, when the insulator 110 insulates vibration, the second rubber damper 112 may be displaced in the upward/downward direction (e.g., vertical direction) due to compression and prolongation behaviors to damp vibration.

In this way, the insulator 110 may optimize tuning by using the first and second rubber dampers 111 and 112 having different hardness characteristics.

The stoppers 120 may be closely attached and supported on a lower surface of the first rubber damper 111 and an upper surface of the second rubber damper 112 of the insulator 110 in a coupled state.

As an example, the stoppers 120 may include a first stopper 121 that is closely attached to and supported on the lower surface of the first rubber damper 111 and a second stopper 122 that is closely attached to and supported by the upper surface of the second rubber damper 112.

It is preferable that the stoppers 120 are formed of a hard steel material to facilitate adjustment of characteristics during compression and prolongation behaviors of the insulator 110. However, the present disclosure is not necessarily limited thereto, and a material, characteristics of which may be easily controlled, may be adopted.

The first stopper 121 and the second stopper 122 may be formed in a cylindrical shape, one side of which is opened and an opposite side of which is closed to surround the first rubber damper 111 and the second rubber damper 112, respectively.

The first stopper 121 and the second stopper 122 may include a horizontal plate (also referred to as a horizontal plate part) 120a having a circular shape having an attachment surface on an inner side thereof to be closely attached and supported on the lower surface of the first rubber damper 111 and the upper surface of the second rubber damper 112, respectively. Furthermore, it may also include a vertical circumferential surface part (also referred to as a vertical circular wall) 120b that extends in a vertical direction along an outer circumference of the horizontal plate 120a.

Furthermore, fastening holes 123 may be formed at central portions of the first stopper 121 and the second stopper 122 so that the fastener 140, such as a bolt, may be fastened and fixed (e.g., affixed).

Radial direction characteristics (twisting characteristics) of the insulator 110 may be implemented by the stoppers 120 having the above shape in the same way. That is, the twisting characteristics of the forward/rearward direction (e.g., longitudinal direction) or leftward direction behavior, as well as the upward/downward direction (e.g., vertical direction) behavior of the insulator 110, may be adjusted by the stoppers 120.

Additionally, the compressive behavior of the insulator 110 by the first stopper 121 may adjust downward direction characteristics, and the prolongation behavior of the insulator 110 by the second stopper 122 may adjust upward direction characteristics.

The stoppers 120 of the damping device 100 configured in this way may improve a durability by limiting the torsional behavior of the insulator 110 so that the insulator 110 does not exceed a deformation limit due to a compression load. That is, when the hydrogen storage module (e.g., hydrogen storage tank) is moved in the forward/rearward direction (e.g., longitudinal direction) or the leftward/rightward direction (e.g., lateral direction), the stoppers 120 may limit the torsional behavior of the insulator 110 while an outer surface of the insulator 110 contacts the stoppers 120.

Furthermore, the stoppers 120 may fix (e.g., affix) the insulator 110 entirely at the top and the bottom during the upward/downward (e.g., vertical) behavior of the insulator 110, in which the rubber characteristics of the insulator 110 increase. Accordingly, the stoppers 120 may restrict the insulator 110 to minimize the movement of the insulator 110.

The stoppers 120 may improve the durability of the insulator 110 by restricting not only the upward/downward (e.g., vertical) behavior but also the torsional behavior of the insulator 110 so that the rubber characteristics of the insulator 110 are adjusted to be hard.

An upper portion of the first stopper 121 may further include a plate-shaped (e.g., disc-shaped) thickness adjusting plate (also referred to as a washer or a spacer) 130 that may selectively adjust the thickness to adjust (e.g., tune) the desired upward/downward direction (e.g., vertical direction) characteristics of the insulator 110 depending on the thickness.

The thickness adjusting plate (e.g., washer) 130 may be set to various thicknesses to adjust the upward/downward direction (e.g., vertical direction) characteristics of the insulator 110. That is, the thickness of the thickness adjusting plate (e.g., washer) 130 may be variously changed and adjusted depending on the upward/downward direction (e.g., vertical direction) characteristics of the insulator 110. Here, it is preferable that the thickness adjusting plate (e.g., washer) 130 is formed of a hard steel material to facilitate adjustment of characteristics during the compression and prolongation behaviors of the insulator 110, but the present disclosure is not necessarily limited thereto, and a material that facilitates adjustment of characteristics during the compression and prolongation behaviors of the insulator 110 may be adopted.

Fastening holes 123 and 131 may be formed at central portions of the stoppers 120 and the thickness adjusting plate (e.g., washer) 130 so that the fastener 140, such as a bolt, may be fastened and fixed (e.g., affixed).

The damping device 100 including the insulator 110, the stoppers 120, and the thickness adjusting plate (e.g., washer) 130 may be installed between the upper and lower brackets 10 and 20 fixed (e.g., affixed) to the frame structure of the hydrogen storage module (e.g., hydrogen storage tank), and the vehicle body frame, respectively.

The upper and lower brackets 10 and 20 may include a first horizontal plate 11 and a second horizontal plate 21, respectively.

A damping device mounting hole 11a, in which the damping device 100 is mounted, may be formed in the first horizontal plate 11, and a fastening hole 21a, to which the fastener 140 is fastened and fixed (e.g., affixed), may be formed in the second horizontal plate 21.

The first horizontal plate 11 is formed to have a thickness corresponding to the support part 111b of the first rubber damper 111, and when the first body 111a and the second body part 112a is closely attached to and supported on the upper and lower surfaces of the first horizontal plate 11 while the support part 111b of the first rubber damper 111 is inserted into the damping device mounting hole 11a, the insulator 110 may be firmly coupled to the upper bracket 20.

FIG. 3 is a partially cutaway perspective view of the mount for a hydrogen storage module (e.g., hydrogen storage tank) for a vehicle fixed (e.g., affixed) to the upper and lower brackets, and a process of coupling the damping device 100 to the upper and lower brackets 10 and 20 will be described.

The first rubber damper 111 and the first stopper 121 may be installed on a lower side of the first horizontal plate 11 of the upper bracket 10, and the second rubber damper 112, the second stopper 122, and the thickness adjusting plate (e.g., washer) 130 may be installed on an upper side thereof.

An attachment surface of the first stopper 121 may be closely attached to and supported on a lower surface of the first rubber damper 111, and an attachment surface of the second stopper 122 may be closely attached to and supported by an upper surface of the second rubber damper 112.

First, with respect to the first horizontal plate 11 of the upper bracket 10, the first rubber damper 111 and the second rubber damper 112 of the insulator 110 may be fixed (e.g., affixed) to the damping device mounting hole 11a of the first horizontal plate 11 of the upper bracket 10.

When the first rubber damper 111 is inserted into the damping device mounting hole 11a formed in the first horizontal plate 11, the through-hole 112b may be mounted on and fixed (e.g., affixed) to the insertion part 111c of the first rubber damper 111 in a state, in which the support part 111b and the insertion part 111c of the first rubber damper 111 are inserted into the damping device mounting hole 11a.

In this case, a height (e.g., depth) of the damping device mounting hole 11a formed in the first horizontal plate 11 of the upper bracket 10 may be substantially the same as a height of the support part 111b of the first rubber damper 111.

Accordingly, the first body part 111a of the first rubber damper 111 and the second body part 112a of the second rubber damper 112 may be pressed (e.g., depressed) against and fixed (e.g., affixed) to the upper and lower surfaces of the first horizontal plate 11, respectively.

In this way, in a state, in which the first rubber damper 111 and the second rubber damper 112 are coupled to the first horizontal plate 11 of the upper bracket 10, the first stopper 121 and the second stopper 122 may be firmly closely attached to the lower surface of the first rubber damper 111 and the upper surface of the second rubber damper 112.

In this state, a thickness adjusting plate (e.g., washer) 130 having a thickness that is suitable for adjusting the rubber characteristics of the insulator 110 may be closely attached to and supported on the second stopper 122.

In a state, in which the insulator 110, the stoppers 120, and the thickness adjusting plate (e.g., washer) 130 are coupled to the upper bracket 10, the shaft pipe 150 may be inserted into and fixed (e.g., affixed) to the insulator 110.

The insulator 110, the stoppers 120, and the thickness adjusting plate (e.g., washer) 130 may be fixed (e.g., affixed) by a fastener 140.

In this case, the fastener 140 may be fastened to the fastening holes 123 and 131 of the stoppers 120 and the thickness adjusting plate (e.g., washer) 130, and the shaft pipe 150 inserted into the insulator 110. That is, after the fastener 140 is fastened to the fastening hole 21a of the second horizontal plate 21 formed in the lower bracket 20, it may be fastened to the first stopper 121 of the damping device 100, the shaft pipes 150 of the first rubber damper 111 and the second rubber damper 112, the second stopper 122, and the thickness adjusting plate (e.g., washer) 130.

Subsequently, a nut 145 may be fastened to a screw thread formed at an end of the fastener 140 to fix (e.g., affix) the upper and lower brackets 10 and 20, to which the damping device 100 is firmly coupled, between the hydrogen storage module (e.g., hydrogen storage tank) and the vehicle body.

In this way, the damping device 100 that secures insulation of vibration of a road surface, which is transmitted to the hydrogen storage module (e.g., hydrogen storage tank), may be fixed (e.g., affixed) between the upper bracket 10 fixed (e.g., affixed) to the hydrogen storage module (e.g., hydrogen storage tank), and the lower bracket 20 fixed (e.g., affixed) to the vehicle body frame of the hydrogen-powered vehicle.

Hereinafter, in describing the stoppers 120, a detailed description of a configuration that is duplicative will be omitted to avoid a repeated description.

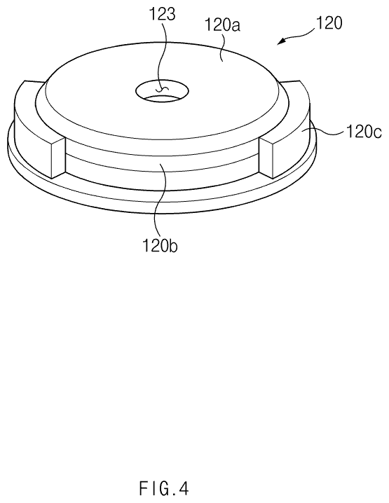

FIG. 4 is a perspective view illustrating the stoppers 120 of the mount for the hydrogen storage module (e.g., hydrogen storage tank) for a vehicle.

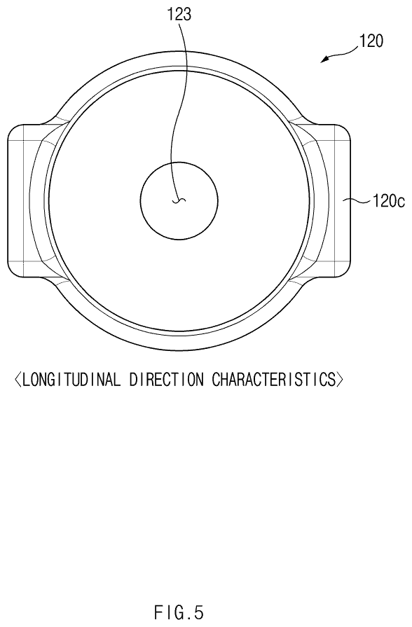

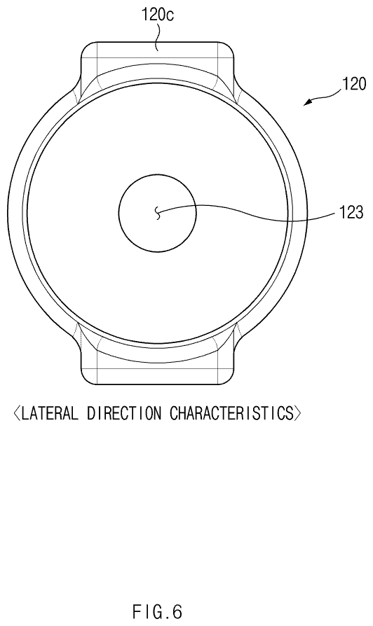

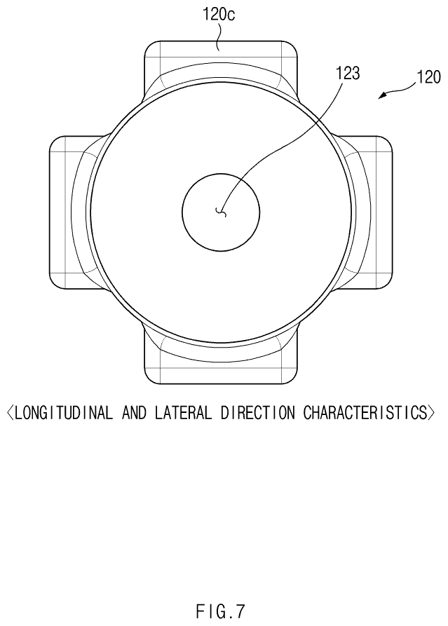

Furthermore, FIG. 5 is a view illustrating an arrangement state of an extension groove of a stopper for adjusting forward/rearward direction (e.g., longitudinal direction) characteristics of an insulator. FIG. 6 is a view illustrating an arrangement state of an extension groove of a stopper for adjusting leftward/rightward direction (e.g., lateral direction) characteristics of an insulator. FIG. 7 is a view illustrating an arrangement state of an extension groove of a stopper for adjusting forward/rearward and leftward/rightward direction (e.g., lateral direction) characteristics of an insulator.

The stoppers 120 may include a first stopper 121 including a lower attachment surface that is closely attached to and supported on the first rubber damper 111, and a second stopper 122 including an upper attachment surface that is closely attached to and supported on the second rubber damper 112.

The first stopper 121 and the second stopper 122 may be formed to surround the first rubber damper 111 and the second rubber damper 112 corresponding to each other, respectively. That is, the first stopper 121 and the second stopper 122 may include a circular horizontal plate 120a having an attachment surface that is closely attached to and supported on the first rubber damper 111 and the second rubber damper 112, and a vertical circumferential surface part 120b that extends in a vertical direction along an outer circumference of the horizontal plate 120a.

Furthermore, the first stopper 121 and the second stopper 122 may include a pair of extension grooves (also referred to as extension groove parts) 120c that integrally extend outward from the vertical circumferential surface part 120b. The pair of extension groove 120c may be disposed in a row on opposite sides of the vertical circumferential surface part 120b of the stoppers 120.

An extension groove 120c of the stoppers 120 may be a rubber characteristic adjustment groove that is formed in the forward/rearward direction (e.g., longitudinal direction) or the leftward/rightward direction (e.g., lateral direction) side of the stoppers 120 to adjust the rubber characteristics of the insulator 110.

Accordingly, the stoppers 120 may adjust a z-direction behavior corresponding to upward/downward direction (e.g., vertical direction) characteristics of the insulator 110, and may adjust x and y-direction torsional behaviors corresponding to the forward/rearward direction (e.g., longitudinal direction) or leftward/rightward direction (e.g., lateral direction) characteristics of the insulator 110 as well.

Referring to FIGS. 5 and 6, the forward/rearward direction (e.g., longitudinal direction) of the damping device 100 is based on the forward/rearward direction (e.g., longitudinal direction) of the vehicle body, the forward/rearward direction (e.g., longitudinal direction) of the damping device 100 and the forward/rearward direction (e.g., longitudinal direction) of the vehicle body are the same, and in the following description, the “x” direction may correspond to the forward/rearward direction (e.g., longitudinal direction) of the vehicle body while the damping device 100 is mounted on the vehicle body, and the “z” direction may correspond to the upward/downward direction (e.g., vertical direction) of the vehicle body. Furthermore, in the following description, the “y” direction is a direction that is perpendicular to the “x” direction and the “z” direction, and may correspond to the leftward/rightward direction (e.g., lateral direction) of the damping device 100 and the vehicle body.

Accordingly, an adjustment corresponding to the forward/rearward direction or leftward/rightward direction characteristics of the insulator 110 (e.g., adjustment of a longitudinal or lateral position of the insulator 110) of FIGS. 5 and 6 and the forward/rearward direction (e.g., longitudinal direction) and the leftward/rightward direction (e.g., lateral direction) of FIG. 7 may be performed according to an extension direction of the extension groove 120c.

In this way, the forward/rearward direction (e.g., longitudinal direction) or leftward/rightward direction (e.g., lateral direction) characteristics, and the forward/rearward (e.g., longitudinal) and leftward/rightward (e.g., lateral) directions of the insulator 110 may be independently controlled to perform adjusting according to the durability and vehicle behavior characteristics of the damping device.

Furthermore, according to the present disclosure, an adjustment corresponding to the upward/downward direction (e.g., vertical direction) characteristics (e.g., the vertical position) of the insulator 110 may performed by adjusting the length of the vertical circumferential surface part 120b of the stoppers 120.

In this way, characteristics for controlling the behavior of the insulator 110 may be adjusted and applied through the length of the vertical circumferential surface part 120b of the stoppers 120, the degrees of hardness of the first and second rubber dampers 111 and 112 of the insulator 110, and the extension groove 120c of the stoppers 120.

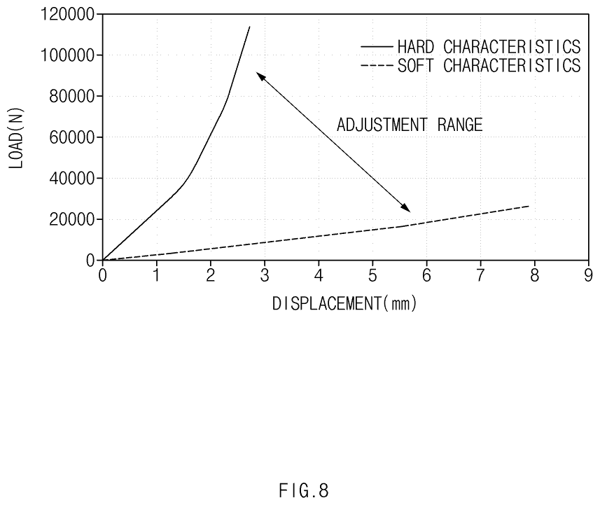

FIG. 8 is a graph depicting an adjustment range between hardness characteristic curves of the insulator 110 due to adjustment of the length of the vertical circumferential surface part 120b of the stoppers 120 according to the present disclosure, and is a characteristic graph depicting a change in a displacement value of the insulator 110 depending on an input load.

That is, it is possible to know the change in the displacement value depending on the load of the insulator 110 according to the length adjustment of the vertical circumferential surface part 120b of the stoppers 120.

Here, the left curve of the graph represents the rubber characteristics in a state, in which the rubber characteristics of the insulator 110 are hard, when the length of the vertical circumferential surface part 120b of the stoppers 120 increases, and the right curve of the graph represents rubber characteristics in at state, in which the rubber characteristics of the insulator 110 are soft when the length of the vertical circumferential surface part 120b of the stoppers 120 is reduced, and an adjustment may be made for the hardness of the insulator 110 depending on the shape of the stoppers 120.

That is, it may be applied by adjusting the adjustment range between the hard-state rubber characteristics of the insulator and the soft-state rubber characteristics.

In this way, it may be seen that in the damping device 100 according to the present disclosure, the upward/downward direction (e.g., vertical direction) characteristics of the insulator 110 are changed by adjusting the height of the stoppers 120. Because, this optimizes the adjustment of the vehicle in a manner, in which the characteristics are changed by adjusting the displacement of the insulator 110, the performance of the vehicle against the vibration insulation of the vehicle may be improved.

Accordingly, the damping device 100 according to the present disclosure may selectively control the forward/rearward direction (e.g., longitudinal direction) or leftward/rightward direction (e.g., lateral direction) characteristics as well as the upward/downward direction (e.g., vertical direction) characteristics against an impact to the hydrogen tank and the frame structures during turning and sudden stopping of the vehicle to secure the vibration insulation of the hydrogen storage module (e.g., hydrogen storage tank).

According to an aspect of the present disclosure, a fixation device of a hydrogen storage module for a vehicle fixed between the hydrogen storage module and a vehicle body frame via upper and lower brackets includes an insulator that insulates vibration of the hydrogen storage module, and a stopper including a first stopper and a second stopper provided with attachment surfaces supported by upper and lower surfaces of the insulator to be closely attached thereto.

The fixation device may further include a thickness adjusting plate provided at an upper portion of the first stopper and that tunes upward/downward characteristics of the insulator depending on a thickness thereof.

Two rubber dampers of different hardnesses may be coupled to each other in the insulator.

The insulator includes a first rubber damper, and a second rubber damper having a lower hardness than that of the first rubber damper, and coupled to an upper side of the first rubber damper.

The first rubber damper may include a first body part, a support part formed at an upper portion of the first body part while sharing a center of the first body part, and a diameter of which is formed to be smaller than that of the first body part, and an insertion part formed at an upper portion of the support part while sharing a center of the support part, and a diameter of which is formed to be smaller than that of the support part.

The second rubber damper may include a second body part, in which a through-hole, into which the insertion part of the first rubber damper is inserted to be fixed, is formed at a central portion thereof.

The stopper may include a vertical circumferential surface part extending vertically along a circumference of the attachment surface.

The stopper may tune upward/downward direction characteristics of the insulator depending on a length of the vertical circumferential surface part.

The stopper may include a plurality of extension groove parts integrally extending outward from the vertical circumferential surface part.

The pair of extension groove parts may be disposed in a row on opposite sides of the vertical circumferential surface part.

According to the fixation device of the hydrogen storage module for a vehicle according to the present disclosure having the above-described configuration, impact vibration of a road surface against the hydrogen storage module of the vehicle may be absorbed, and a degree of freedom of design, by which the forward/rearward direction (e.g., longitudinal direction) or leftward/rightward direction (e.g., lateral direction) characteristics as well as the upward/downward characteristics of the hydrogen storage module may be controlled, may be secured.

In addition, because the stopper may limit the behavior of the insulator during vibration of the vehicle to prevent interferences with surrounding structures of the hydrogen storage module, a degree of freedom of design of the hydrogen storage module in an aspect of a layout of the vehicle may be improved.

A noise, vibration, and harshness (NVH) and ride and handling (R&H) performances may be satisfied by adjusting the upward/downward direction, forward/rearward direction (e.g., longitudinal direction) or leftward/rightward direction (e.g., lateral direction) characteristics of the hydrogen storage module.

A durable robustness of the insulator may be secured by variously adjusting characteristic adjusting manners depending on the hardness and the shape of the insulator, and the shape of the stopper.

The durability of the insulator may be improved by restricting compressive deformation of the insulator through the stopper such that the insulator does not exceed a deformation limit point due to a compressive load.

The above-mentioned description of the present disclosure is intended to be illustrative, and it should be understood by those skilled in the art that the present disclosure may be embodied in other specific forms without departing from the spirit or essential characteristics thereof. Therefore, the above-described embodiments are examples in all aspects, and should be construed not to be restrictive. The scope of the present disclosure is defined by claims to be described below, and it should be interpreted that the scopes or claims of the present disclosure and all modifications or changed forms derived from the equivalent concept are included in the scopes of the present disclosure.

What is claimed is:

1. A mount for a hydrogen storage tank of a vehicle, the mount comprising:
an insulator configured to insulate vibration of the hydrogen storage tank; and
a plurality of stoppers comprising a first stopper and a second stopper, wherein the first stopper comprises a first attachment surface supporting an upper surface of the insulator, and wherein the second stopper comprises a second attachment surface supporting a lower surface of the insulator.

2. The mount of claim 1, further comprising:
a washer provided at an upper portion of the first stopper and configured to adjust, by a thickness of the washer, a vertical position of the insulator.

3. The mount of claim 1, wherein the insulator comprises:
two rubber dampers, of different degrees of hardness, being coupled to each other.

4. The mount of claim 3, wherein the two rubber dampers comprise:
a first rubber damper; and
a second rubber damper having a lower degree of hardness than the first rubber damper, wherein the second rubber damper is coupled to an upper side of the first rubber damper.

5. The mount of claim 4, wherein the first rubber damper comprises:
a disk body having a first diameter;
a support disk formed on the disk body, wherein the disk body and the support disk are concentric, and wherein the support disk has a second diameter that is less than the first diameter; and
an insertion disk formed on the support disk, wherein the support disk and the insertion disk are concentric, and wherein the insertion disk has a third diameter that is less the second diameter.

6. The mount of claim 5, wherein the second rubber damper comprises:
a torus body with a through-hole, into which the insertion disk of the first rubber damper is inserted and affixed.

7. The mount of claim 1, wherein each of the plurality of stoppers further comprises a vertical circular wall extending vertically along a circumference of at least one of the first attachment surface or the second attachment surface.

8. The mount of claim 7, wherein each of the plurality of stoppers is configured to adjust, by a length of the vertical circular wall, a vertical position of the insulator.

9. The mount of claim 7, wherein each of the plurality of stoppers comprises a plurality of extension grooves integrally extending outward from the vertical circular wall.

10. The mount of claim 9, wherein the plurality of extension grooves comprises a pair of extension grooves that are disposed on opposite sides of the vertical circular wall.

11. The mount of claim 1, wherein the insulator is disposed between the first stopper and the second stopper such that a first circular wall of the first stopper and a second circular wall of the second stopper are in contact with the insulator,
wherein a first through-hole is formed on the insulator, wherein the insulator is inserted through a second through-hole that is formed on a first bracket, wherein the first bracket is affixed to the hydrogen storage tank.

12. The mount of claim 11, further comprising:
a bolt penetrating through:
a through-hole formed on a second bracket, wherein the second bracket is affixed to a body frame of the vehicle,
a through-hole formed on a first disk of the first stopper,
the first through-hole,
the second through-hole,
a through-hole formed on a second disk of the second stopper,
a washer disposed on the second stopper, and
a nut disposed on the washer.

13. A mount for a hydrogen storage tank of a vehicle, the mount comprising:
a first stopper comprising a first disk and a first circular wall vertically extending from a first circumferential edge of the first disk, wherein a first through-hole is formed on the first disk, the first through-hole being concentric to the first disk;
a second stopper comprising a second disk and a second circular wall vertically extending from a second circumferential edge of the second disk, wherein a second through-hole is formed on the second disk, the second through-hole being concentric to the second disk;
an insulator disposed between the first stopper and the second stopper such that the first circular wall and the second circular wall are in contact with the insulator, wherein a third through-hole is formed on the insulator, wherein the insulator is inserted through a fourth through-hole that is formed on a first bracket, and wherein the first bracket is affixed to the hydrogen storage tank; and
a bolt penetrating through:
a fifth through-hole formed on a second bracket, wherein the second bracket is affixed to a body frame of the vehicle,
the first through-hole,
the third through-hole,
the fourth through-hole,
the second through-hole,
a washer disposed on the second stopper, and
a nut disposed on the washer.

14. The mount of claim 13, wherein the insulator comprises:
two rubber dampers, of different degrees of hardness, being coupled to each other.

15. The mount of claim 14, wherein one of the two rubber dampers comprises:
a disk body having a first diameter;
a support disk formed on the disk body, wherein the disk body and the support disk are concentric, and wherein the support disk has a second diameter that is less than the first diameter; and
an insertion disk formed on the support disk, wherein the support disk and the insertion disk are concentric, and wherein the insertion disk has a third diameter that is less the second diameter.
